(19) United States
(12) Patent Application Publication
(10) Pub. No.: US 2024/0020147 A1
(43) Pub. Date: Jan. 18, 2024

(54) LOAD BALANCING WITH SERVICE-TIER AWARENESS

(71) Applicant: VMWARE, INC., Palo Alto, CA (US)

(72) Inventor: AMOL MANOHAR VAIKAR, Pune (IN)

(21) Appl. No.: 17/960,863

(22) Filed: Oct. 6, 2022

(30) Foreign Application Priority Data
Jul. 16, 2022 (IN) 202241040758

(51) Int. Cl. G06F 9/455

(52) U.S. Cl. CPC G06F 9/45558; G06F 2009/4557; G06F 2009/45595

(57) ABSTRACT

Example methods and systems for load balancing with service-tier awareness are described. One example may involve a computer system receiving, from a client system, a service request that requires processing by one of multiple server pools that are reachable via the computer system. The multiple server pools may be associated with respective multiple service tiers. The computer system may obtain identity information identifying a user associated with the service request from the client system; and based on the identity information, mapping the service request to a particular service tier from the multiple service tiers. Next, a particular server pool that is associated with the particular service tier may be identified from the multiple server pools. The service request may be steered towards a destination server for processing, the destination server being selected from the particular server pool associated with the particular service tier.

### RELATED APPLICATIONS

Benefit is claimed under 35 U.S.C. 119(a)-(d) to Foreign Application Serial No. 202241040758 filed in India entitled “LOAD BALANCING WITH SERVICE-TIER AWARENESS”, on Jul. 16, 2022, by VMware, Inc., which is herein incorporated in its entirety by reference for all purposes.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtualization computing instances such as virtual machines (VMs) running different operating systems may be supported by the same physical machine (e.g., referred to as a “host”). Each VM is generally provisioned with virtual resources to run an operating system and applications. The virtual resources may include central processing unit (CPU) resources, memory resources, storage resources, network resources, etc. In practice, cloud-native software application(s) implemented in the SDN environment may be delivered to users using a software as a service (SaaS) model. Since users may have different quality of service (QoS) requirements, it may be desirable to service users according to multiple service tiers.

### BRIEF DESCRIPTION OF DRAWINGS

FIG. 1 is a schematic diagram illustrating an example software-defined networking (SDN) environment in which load balancing with service-tier awareness may be performed;

FIG. 2 is a schematic diagram illustrating an example physical view of hosts in an SDN environment;

FIG. 3 is a flowchart of an example process for a computer system to perform load balancing with service-tier awareness;

FIG. 4 is a flowchart of an example detailed process for a computer system to perform load balancing with service-tier awareness;

FIG. 5 is a schematic diagram illustrating a first example of load balancing with service-tier awareness in an SDN environment;

FIG. 6 is a schematic diagram illustrating a second example of load balancing with service-tier awareness in an SDN environment.

### DETAILED DESCRIPTION

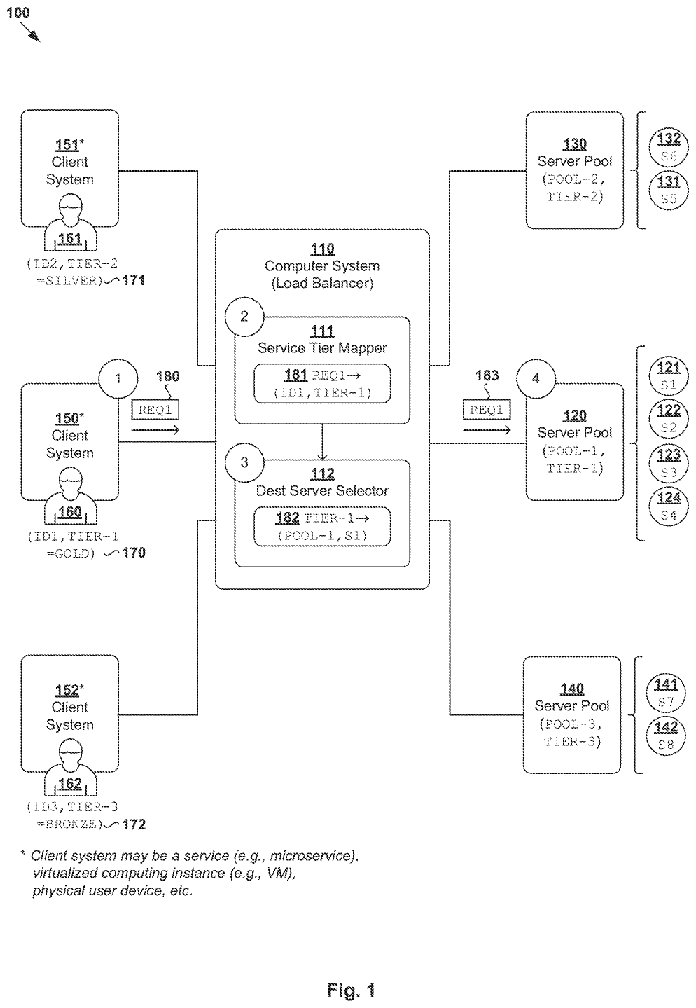

According to examples of the present disclosure, load balancing with service-tier awareness may be implemented to steer service requests to different server pools based on service tiers assigned to respective users. Examples of the present disclosure may be implemented to improve, inter alia, software application delivery, such as according to a software as a service (SaaS) delivery model. One example may involve a computer system (e.g., 110 in FIG. 1) receiving, from a client system (e.g., 150 in FIG. 1), a service request that requires processing by one of multiple server pools (e.g., POOL-1 120, POOL-2 130 and POOL-3 140 in FIG. 1) that are reachable via the computer system. The multiple server pools may be associated with respective multiple service tiers (e.g., TIER-1 170, TIER-2 171 and TIER-3 172 in FIG. 1).

Next, the computer system may obtain identity information identifying a user (e.g., 160 in FIG. 1) associated with the service request from the client system. Based on the identity information, the service request may be mapped to a particular service tier (e.g., TIER-1 170) from the multiple service tiers. Further, a particular server pool (e.g., POOL-1 120) that is associated with the particular service tier may be identified from the multiple server pools. This way, the service request may be steered towards a destination server for processing, the destination server being selected from the particular server pool associated with the particular service tier.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

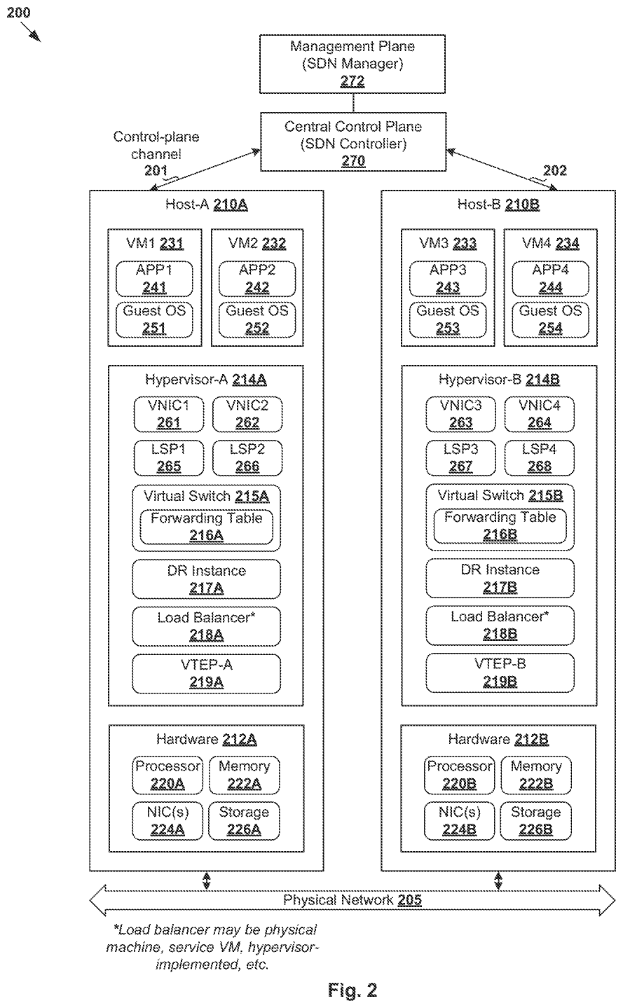

FIG. 1 is a schematic diagram illustrating example software-defined networking (SDN) environment 100 in which load balancing with service-tier awareness may be performed. FIG. 2 is a schematic diagram illustrating example physical view 200 of hosts in SDN environment 100. It should be understood that, depending on the desired implementation, SDN environment 100 may include additional and/or alternative components than that shown in FIG. 1 and FIG. 2. In practice, SDN environment 100 may include any number of hosts (also known as “computer systems,” “computing devices”, “host computers”, “host devices”, “physical servers”, “server systems”, “transport nodes,” etc.).

In the example in FIG. 1, load balancer 110 may be deployed to perform traffic distribution to multiple (N) server pools that are each denoted as POOL-i, where i=1, . . . , N. Each server pool may include backend server(s) capable of processing service requests, such as application server(s), database server(s), web server(s), etc. For example in FIG. 1, three server pools may be configured, including first server pool 120 (denoted as POOL-1), second server pool 130 (POOL-2) and third server pool 140 (POOL-3). Any suitable number (≥1) of backend server may be assigned to each pool, such as four servers 121-124 in POOL-1 120, two servers 131-132 in POOL-2 130 and two servers 141-142 in POOL-3 140.

In practice, server pools 120-140 may be deployed to provide software as a service (SaaS) to facilitate delivery of cloud-native software application(s) over the Internet as a service. Such cloud-native software application(s) may be developed, maintained, and updated by a software provider while users 160-162 may lower operating costs compared to maintaining on-premise hardware and/or software. Using a microservice architecture, for example, each backend server in a particular server pool (POOL-i) may implement a microservice that is capable of processing service requests. In practice, the term “microservices” may refer generally to a collection of small and independent services that are deployed and implemented independently.

Service requests may originate from multiple client systems 150-152 associated with respective users 160-162. As used herein, the term “client system” may refer generally to a physical machine (e.g., user device), virtualized computing instance (e.g., virtual machine (VM), container) implementing a service/microservice, etc. In practice, load balancer 110 may act as an entry point or gateway for users 160-162 to access microservices running on different backend servers. For example, load balancer 110 may act as a gateway and perform north-south traffic distribution to steer service requests from client systems 150-152 towards server pools 120-140. Alternatively or additionally, load balancer 110 may perform east-west load traffic distribution to steer service requests from client systems 150-152 towards server pools 120-140 located within the same data center.

Some example VMs 231-234 that may be used to implement one or more of the following will be described using FIG. 2: load balancer 110, client system 150/151/152, and backend server 121/122/123/124/131/132/141/142 assigned to particular server pool 120/130/140. For example, load balancer 110 may be implemented using a physical (bare metal) machine, hypervisor on a host, a service virtual machine (SVM), etc. Using the example in FIG. 2, “computer system” 110 implementing a load balancer may be VM 231/232/233/234 or host 210A/210B with hypervisor-implemented load balancer 218A/219A.

### Physical Implementation View

In more detail, host 210A/210B may include suitable hardware 212A/212B and virtualization software (e.g., hypervisor-A 214A, hypervisor-B 214B) to support various VMs. For example, host-A 210A may support VM1 231 and VM2 232, while VM3 233 and VM4 234 are supported by host-B 210B. Hardware 212A/212B includes suitable physical components, such as central processing unit(s) (CPU(s)) or processor(s) 220A/220B; memory 222A/222B; physical network interface controllers (PNICs) 224A/224B; and storage disk(s) 226A/226B, etc.

Hypervisor 214A/214B maintains a mapping between underlying hardware 212A/212B and virtual resources allocated to respective VMs. Virtual resources are allocated to respective VMs 231-234 to support a guest operating system (OS; not shown for simplicity) and application(s); see 241-244, 251-254. For example, the virtual resources may include virtual CPU, guest physical memory, virtual disk, virtual network interface controller (VNIC), etc. Hardware resources may be emulated using virtual machine monitors (VMMs). For example in FIG. 2, VNICs 261-264 are virtual network adapters for VMs 231-234, respectively, and are emulated by corresponding VMMs (not shown) instantiated by their respective hypervisor at respective host-A 210A and host-B 210B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 214A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” a network or Internet Protocol (IP) layer; and “layer-4” a transport layer (e.g., using Transmission Control Protocol (TCP), User Datagram Protocol (UDP), etc.), in the Open System Interconnection (OSI) model, although the concepts described herein may be used with other networking models.

SDN controller 270 and SDN manager 272 are example network management entities in SDN environment 100. One example of an SDN controller is the NSX controller component of VMware NSX® (available from VMware, Inc.) that operates on a central control plane. SDN controller 270 may be a member of a controller cluster (not shown for simplicity) that is configurable using SDN manager 272. Network management entity 270/272 may be implemented using physical machine(s), VM(s), or both. To send or receive control information, a local control plane (LCP) agent (not shown) on host 210A/210B may interact with SDN controller 270 via control-plane channel 201/202.

Through virtualization of networking services in SDN environment 100, logical networks (also referred to as overlay networks or logical overlay networks) may be provisioned, changed, stored, deleted and restored programmatically without having to reconfigure the underlying physical hardware architecture. Hypervisor 214A/214B implements virtual switch 215A/215B and logical distributed router (DR) instance 217A/217B to handle egress packets from, and ingress packets to, VMs 231-234. In SDN environment 100, logical switches and logical DRs may be implemented in a distributed manner and can span multiple hosts.

For example, a logical switch (LS) may be deployed to provide logical layer-2 connectivity (i.e., an overlay network) to VMs 231-234. A logical switch may be implemented collectively by virtual switches 215A-B and represented internally using forwarding tables 216A-B at respective virtual switches 215A-B. Forwarding tables 216A-B may each include entries that collectively implement the respective logical switches. Further, logical DRs that provide logical layer-3 connectivity may be implemented collectively by DR instances 217A-B and represented internally using routing tables (not shown) at respective DR instances 217A-B. Each routing table may include entries that collectively implement the respective logical DRs.

Packets may be received from, or sent to, each VM via an associated logical port. For example, logical switch ports 265-268 (labelled “LSP1” to “LSP4”) are associated with respective VMs 231-234. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 215A-B, whereas a “virtual switch” may refer generally to a software switch or software implementation of a physical switch. In practice, there is usually a one-to-one mapping between a logical port on a logical switch and a virtual port on virtual switch 215A/215B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual eXtensible Local Area Network (VXLAN), Stateless Transport Tunneling (STT), Generic Network Virtualization Encapsulation (GENEVE), Generic Routing Encapsulation (GRE), etc. For example, VXLAN is a layer-2 overlay scheme on a layer-3 network that uses tunnel encapsulation to extend layer-2 segments across multiple hosts which may reside on different layer 2 physical networks. Hypervisor 214A/214B may implement virtual tunnel endpoint (VTEP) 219A/219B to encapsulate and decapsulate packets with an outer header (also known as a tunnel header) identifying the relevant logical overlay network (e.g., VNI). Hosts 210A-B may maintain data-plane connectivity with each other via physical network 205 to facilitate east-west communication among VMs 231-234.

### Service Tiers

In practice, it may be desirable to offer multiple service tiers to users 160-162 with different quality of service (QoS) requirements. For example, first user 160 may be assigned to first service tier 170 (e.g., TIER-1=GOLD), second user 161 to second service tier 171 (e.g., TIER-2=SILVER) and third user 162 to third service tier 172 (e.g., TIER-3=BRONZE). Here, the term “service tier” may refer generally to a category of service that is associated with a set of QoS attributes, such as response time, processing time, throughput measure(s), reliability measure(s), availability measure(s), any combination thereof, etc. Any suitable approach may be used for service tier assignment, such as based on service level agreements (SLAs) associated with respective users 160-162.

Conventionally, a load balancer that steers incoming service requests to backend servers may be oblivious of the different service tiers 170-172 assigned to respective users 160-162. This results in a lack of service tier segregation at the load balancer, which implements conventional load balancing algorithms are not capable of differentiating different service tiers. One conventional approach to address the lack of service tier segregation is to deploy multiple load balancers, i.e., at least one load balancer for each service tier. However, such conventional approach may increase costs, as well as management and processing overheads.

Load Balancing with Service-Tier Awareness

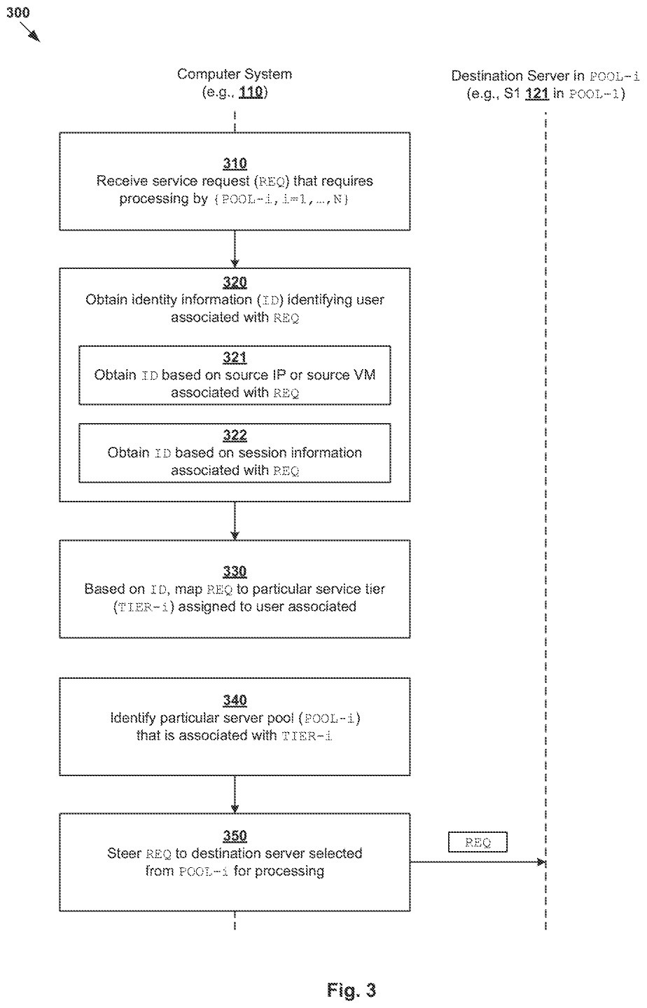

According to examples of the present disclosure, load balancing with service-tier awareness may be implemented to steer service requests to different server pools 120-140 based on service tiers 170-172 assigned to respective users 160-162. Some examples will be described using FIG. 3, which is a flowchart of example process 300 for a first computer system to perform load balancing with service-tier awareness. Example process 300 may include one or more operations, functions, or actions illustrated by one or more blocks, such as 310 to 350. Depending on the desired implementation, various blocks may be combined into fewer blocks, divided into additional blocks, and/or eliminated. Examples of the present disclosure may be implemented using any suitable “computer system” capable of performing load balancing with service-tier awareness, such as computer system 110 in FIG. 1. In practice, computer system 110 in FIG. 1 may include any suitable functional component(s) or module(s) to implement examples of the present disclosure, such as service tier mapper 111 to perform blocks 310-330, destination server selector 112 to perform blocks 340-350 in FIG. 3, etc.

At 310 in FIG. 3, load balancer 110 may receive, from client system 150, a service request (denoted as REQ1 180 in FIG. 1) that requires processing by one of multiple server pools reachable via load balancer. For example in FIG. 1, multiple server pools=(POOL-1 120, POOL-2 130, POOL-3 140) are associated with respective multiple service tiers=(TIER-1 170, TIER-2 171, TIER-3 172).

At 320 in FIG. 3, load balancer 110 may obtain identity information identifying user 160 associated with service request=REQ1 180 from client system 150. As used herein, the term “identity information” may include any suitable identifier (ID) that uniquely identifies a particular user. Depending on the desired implementation, the identity information may include user ID, user token ID, user group information (e.g., Active Directory group), any combination thereof, etc.

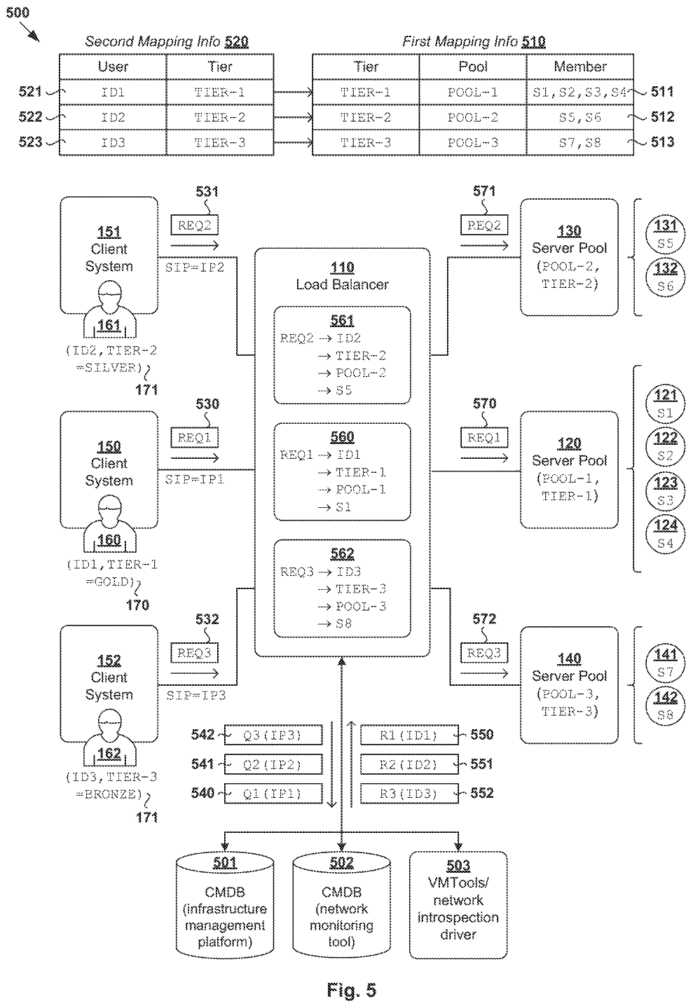

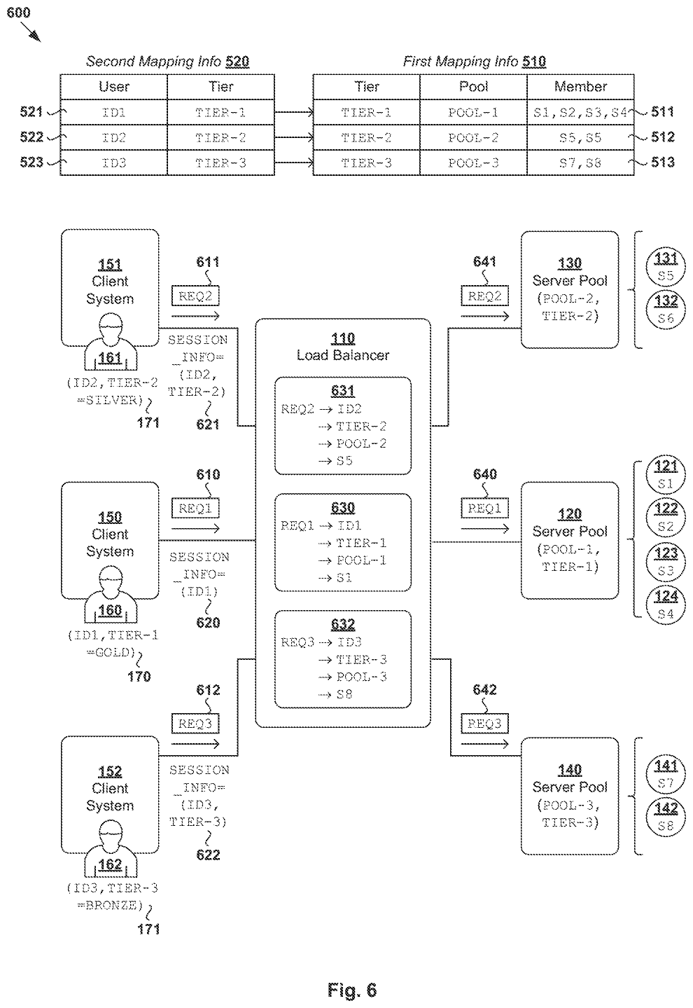

In practice, block 320 may involve obtaining the identity information based on (a) source address information (e.g., source IP address=IP1 associated with client system 150) specified by the service request or (b) client system 150 in the form of a source virtualized computing system. Alternatively or additionally, block 320 may involve obtaining the identity information based on session information extracted from the service request itself. The session information may specify (a) the identity information identifying the user, or (b) both the identity information and the particular service tier. See 321-322 in FIG. 3 (to be discussed using FIGS. 5-6).

At 330 in FIG. 3, based on the identity information, load balancer 110 may map the service request to a particular service tier from the multiple service tiers. For example in FIG. 1, service request=REQ1 180 may be mapped to service tier=TIER-1 170 based on identity information=ID1 identifying user 160 associated with client system 150. See 181 in FIG. 1.

At 340 in FIG. 3, load balancer 110 may identify, from the multiple server pools, particular server pool=POOL-1 120 that is associated with particular service tier=TIER-1. At 350, load balancer 110 may steer service request=REQ1 180 towards destination server=S1 121 from server pool=POOL-1 120 for processing. Since POOL-1 120 include multiple backend servers (i.e., S1-S4 121-124), destination server=S1 121 may be selected from POOL-1 120 according to any suitable approach. See 182-183 in FIG. 1.

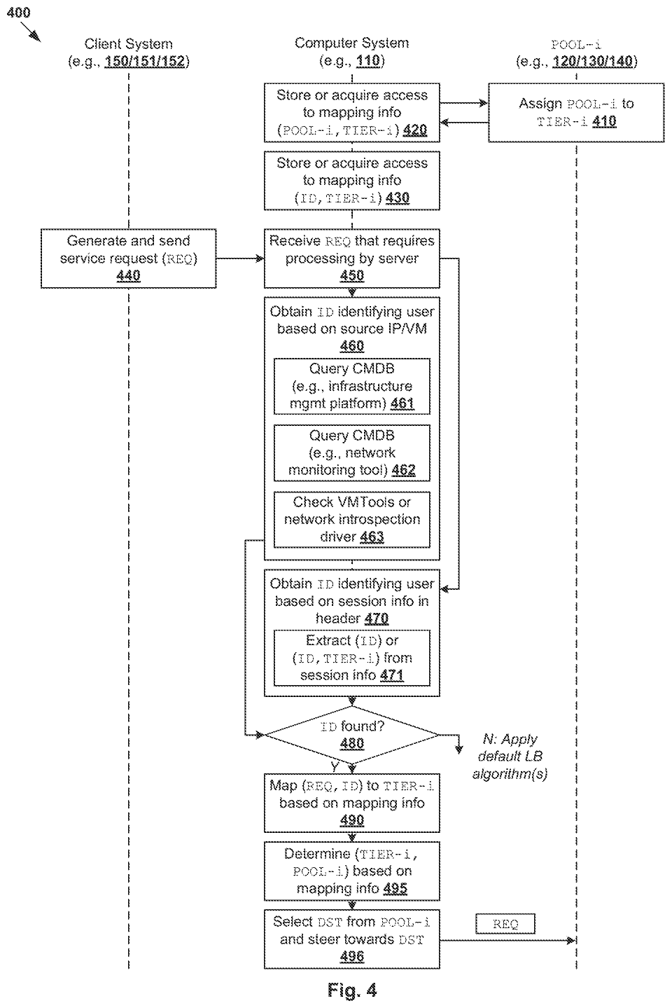

Examples of the present disclosure should be contrasted against conventional approaches that necessitate the deployment of multiple load balancers to perform traffic distribution for respective multiple service tiers. Using load balancer 110 with service-tier awareness according to examples of the present disclosure, service requests may be mapped to different service tiers and respective server pools for processing, such as first user 160 assigned to TIER-1=GOLD 170, second user 161 assigned to TIER-2=SILVER 171 and third user 162 assigned to TIER-3=BRONZE 172. Various examples will be described below using FIGS. 4-6.

### First Example

FIG. 4 is a flowchart of example detailed process 400 for a first computer system to perform load balancing with service-tier awareness in an SDN environment. Example process 400 may include one or more operations, functions, or actions illustrated by one or more blocks, such as 410 to 496. Depending on the desired implementation, various blocks may be combined into fewer blocks, divided into additional blocks, and/or eliminated. The example in FIG. 4 will be described using FIG. 5, which is a schematic diagram illustrating first example 500 of load balancing with service-tier awareness in an SDN environment.

### (a) Mapping Information

At 410 in FIG. 4, multiple server pools (POOL-i) may be assigned to respective multiple service tiers (TIER-i), where i=1, . . . N and N=number of service tiers. Each service tier may be associated with a set of QoS attributes. Using N=3 as an example, first service tier 170 (TIER-1)=GOLD may be associated with a more stringent set of QoS attributes compared to second service tier 171 (TIER-2)=SILVER and third service tier 172 (TIER-3)=BRONZE. In one example, service tiers (TIER-1, TIER-2, TIER-3) may be associated with respective maximum response/processing times=(T1, T2, T3), where T1 <T2 <T3. In another example, service tiers (TIER-1, TIER-2, TIER-3) may be associated with respective service availability percentages=(A1, A2, A3), where A1<A2<A3.

In practice, a particular server pool may include one or multiple members (i.e., backend servers). First server pool 120 (i.e., POOL-1) may include four members=application servers 121-124 (see S1 to S4) to process service requests associated with TIER-1=GOLD 170. Second server pool 130 (i.e., POOL-2) may include two members=application servers 131-132 (see S5 to S7) to process service requests associated with TIER-2=SILVER 171. Third server pool 140 (i.e., POOL-3) may include two members=application servers 141-142 (see S8 to S9) to process service requests associated with TIER-3=BRONZE 172.

Depending on the desired implementation, backend servers 121-124, 131-132 and 141-142 may have the same processing capability, or different processing capabilities. In practice, since TIER-1=GOLD 170 has more stringent QoS requirements, more processing resources may be dedicated to TIER-1 170, such as more servers and/or servers with a higher processing capability compared TIER-2=SILVER 171 and TIER-3=BRONZE 172.

At 420 in FIG. 4, to facilitate service request distribution with service-tier awareness, load balancer 110 may store (or acquire access to) mapping information=(TIER-i, POOL-i) that associates a particular server pool (POOL-i) with a particular service tier (TIER-i). In the example in FIG. 5, mapping information 510 may include the following entries: (TIER-1, POOL-1), (TIER-2, POOL-2) and (TIER-3, POOL-3). Each entry of mapping information 510 may further specify member(s) assigned to each server pool such that service requests may be steered towards a particular member.

At 430 in FIG. 4, may store or acquire access to mapping information=(ID, TIER-i) that associates or maps identity information (ID) identifying a user with a particular service tier (TIER-i). For example in FIG. 5, mapping information 520 may include the following entries: (ID1, TIER-1), (ID2, TIER-2) and (ID3, TIER-3). Here, ID=ID1 identifies first user 160 associated with first client system 150, ID2 identifies second user 161 associated with second client system 151 and ID3 identifies third user 162 associated with third client system 152.

### (b) Service Request Processing

At 440-450 in FIG. 4, load balancer 110 may detect a service request from client system 150/151/152 to request a service provided by backend servers in multiple server pools 120-140. For north-south traffic load balancing, client system 150/151/152 may be a user device operated by user 160/161/162. For east-west traffic load balancing, client system 150/152/152 may be a virtualized computing instance (e.g., VM, container) capable of implementing a microservice in SDN environment 100.

At 460/470 in FIG. 4, load balancer 110 may obtain identity information (ID) identifying user 160/161/162 associated with the service request based on the service request, such as header information and/or payload information. In more detail, a first example (see 460) may involve determining the ID based on source address information (e.g., source IP address) in the header information and/or a source VM from which the service request originates. A second example (see 470) may involve determining the ID based on session information extracted from header information of the service request. Blocks 460 and 470 will be described further using FIGS. 5-6, respectively. Note that block 460 and/or block 470 may be performed in practice, depending on the availability of the ID.

At 480-490 in FIG. 4, in response to identifying the user associated with the service request, load balancer 110 may map the identity information to a particular service tier (TIER-i) assigned to the user. If the identity information is not found at block 460/470, default load balancing algorithm(s) with no service-tier awareness may be applied to select a server from any of the server pools, such as round robin, etc.

At 495 in FIG. 4, load balancer 110 may select a server from a particular server pool (POOL-i) associated with the service tier (TIER-i) to process the service request. Further, at 496, the service request may be forwarded towards the selected server for processing. Some examples will be described using FIGS. 5-6 below.

### First Example (Related to Block 460 in FIG. 4)

Block 460 in FIG. 4 will be further described using FIG. 5. Here, at 530, load balancer 110 may receive a first service request (REQ1) from first client system 150 associated with first user 160. In this example, REQ1 530 may include header information specifying source IP address=IP1. Further, in the case of VM-implemented first client system 150, REQ1 530 may be associated with a source VM (e.g., VM1 234 in FIG. 2).

At 540 in FIG. 5, in response, load balancer 110 may obtain identity information identifying first user 160 by generating and sending a first query (Q1) specifying source IP address=IP1. Example identity information that is mappable to a particular service tier may include a user ID, user token information, user group information, any combination thereof, etc. In practice, Q1 540 may be sent to any suitable system(s) capable of mapping (a) a particular source IP address/source VM to (b) the identity information.

In a first example, Q1 540 may be sent to configuration management database (CMDB) 501 associated with an infrastructure automation platform. One example infrastructure automation platform is VMware's vRealize® Automation (vRA), which is designed to deliver self-service clouds, multi-cloud automation with governance, as well as DevOps-based infrastructure management and security, etc. Here, DevOps refers to development and operations. See also block 461 in FIG. 4.

In a second example, Q1 540 may be sent to CMDB 502 associated with a network monitoring tool. One example network monitoring tool is VMware's vRealize® Network Insight (vRNI), which is facilitates micro-segmentation planning and deployment, troubleshooting of virtual and physical networks, network and security management across public/private clouds, etc. See also block 462 in FIG. 4.

In a third example, Q1 540 may be sent to a VM management tool or network introspection driver to find identity information associated with logged-in user 160. For example, VMware® Tools (VMTools) is a set of services and/or modules to facilitate improved management of guest OS, such as passing messages from host OS (e.g., hypervisor) to guest OS, customize guest OS, run scripts to help automate guest OS operations. See also block 463 in FIG. 4.

At 550 in FIG. 5, based on a response to Q1 540, load balancer 110 may learn that source IP address=IP1 of REQ1 530 is associated with identity information=ID1. Next, at 560, load balancer 110 may map (a) ID1 to (b) service tier=TIER-1 170 based on entry 521=(ID1, TIER-1) in mapping information 520. Further, service tier=TIER-1 170 may be mapped to server pool=POOL-1 120 based on entry 511=(TIER-1, POOL-1) in mapping information 510.

At 570 in FIG. 5, load balancer 110 may select one of multiple backend servers from POOL-1 120 and forward the service request towards the selected server for processing. In particular, based on entry 511 specifying (S1 121, S2 122, S3 123, S4 124) assigned to server pool=POOL-1 120, load balancer 110 may select S1 121 to process REQ1 530 based on any suitable algorithm(s), such as round robin, load-based algorithm, hash-based algorithm, etc.

The above may be repeated for service requests from other users. For example, in response to receiving REQ2 531 from second client system 151, load balancer 110 may obtain identity information=ID2 identifying second user 161 based on query=Q2 542 specifying source IP address=IP2 and response=R2 specifying ID2. This way, load balancer 110 may map ID2 to (TIER-2, POOL-2) and forward REQ2 531 towards one of (S5 131, S6 132) in POOL-2 130 for processing. See 531, 541, 551, 561 and 571.

In another example, in response to receiving REQ3 532 from third client system 152, load balancer 110 may obtain identity information=ID3 identifying third user 162 based on query=Q2 542 specifying source IP address=IP3 and response=R3 specifying ID3. This way, load balancer 110 may map ID3 to (TIER-3, POOL-3) and forward REQ3 532 towards one of (S7 141, S8 142) in POOL-3 140 for processing. See 532, 542, 552, 562 and 572.

### Second Example (Related to Block 470 in FIG. 4)

Block 470 in FIG. 4 will be described using FIG. 6, which is a schematic diagram illustrating second example 600 of load balancing with service-tier awareness in SDN environment 100. As discussed using block 420 in FIG. 4, load balancer 110 may store or acquire access to mapping information 510 specifying (TIER-i, POOL-i), as well as backend server(s) assigned to each POOL-i. Further, as discussed using block 430, load balancer 110 may store or acquire access to mapping information 520 specifying (ID, TIER-i).

At 610-620 in FIG. 6, in response to receiving a first service request (REQ1) from first client system 150, load balancer 110 may obtain identity information=ID1 associated with first user 160 based on session information (also known as context information) in REQ1 610. Depending on the desired implementation, the session information may specify ID1 (e.g., user token information) that uniquely identifies first user 160. The session information may be included in the header information (i.e., service request header) of REQ1 610.

At 630 in FIG. 6, based on the session information, load balancer 110 may map (a) ID1 to (b) service tier=TIER-1 170 based on entry 521=(ID1, TIER-1) in mapping information 520. Further, service tier=TIER-1 170 may be mapped to server pool=POOL-1 120 based on entry 511=(TIER-1, POOL-1) in mapping information 510. In other words, based on the session information, REQ1 610 may be mapped to (ID1, TIER-1, POOL-1).

At 670 in FIG. 6, load balancer 110 may select one of multiple backend servers from POOL-1 120 and forward the service request towards the selected server for processing. In particular, based on entry 511 specifying (S1 121, S2 122, S3 123, S4 124) assigned to server pool=POOL-1 120, load balancer 110 may select S2 122 to process REQ1 610 based on any suitable algorithm(s).

The above may be repeated for service requests from other users. For example, in response to receiving REQ2 611 from second client system 151, load balancer 110 may obtain identity information=ID2 identifying second user 161 based on session information=(ID2, TIER-2). Here, it should be noted that the session information also specifies service tier=TIER-2 associated with ID2. This way, load balancer 110 may map (ID2, TIER-2) to (TIER-2, POOL-2), and forward REQ2 611 towards a destination server selected from (S5 131, S6 132) in POOL-2 130 for processing. See 611, 621, 631 and 641.

In another example, in response to receiving REQ3 612 from third client system 152, load balancer 110 may obtain identity information=ID3 identifying third user 162 based on session information=(ID3, TIER-3). Similarly, the session information also specifies service tier=TIER-2 associated with ID2. This way, load balancer 110 may map ID3 to (TIER-3, POOL-3) and forward REQ3 612 towards a destination server selected from (S7 141, S8 142) in POOL-3 140 for processing. See 612, 622, 632 and 642.

### Container Implementation

Although discussed using VMs 231-234, it should be understood that load balancing with service-tier awareness may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 231, where a different VNIC is configured for each container. Each container is “OS-less”, meaning that it does not include any OS that could weigh 11 s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 6. For example, a computer system capable of acting as load balancer 110 may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

What is claimed is:

1. A method for a computer system to perform load balancing with service-tier awareness, wherein the method comprises:
receiving, from a client system, a service request that requires processing by one of multiple server pools that are reachable via the computer system, wherein the multiple server pools are associated with respective multiple service tiers;
obtaining identity information identifying a user associated with the service request from the client system;
based on the identity information, mapping the service request to a particular service tier from the multiple service tiers;
identifying, from the multiple server pools, a particular server pool that is associated with the particular service tier; and
steering the service request towards a destination server for processing, wherein the destination server is selected from the particular server pool associated with the particular service tier.

2. The method of claim 1, wherein obtaining the identity information comprises:
obtaining the identity information based on (a) source address information specified by the service request or (b) the client system in the form of a source virtualized computing system.

3. The method of claim 2, wherein obtaining the identity information comprises:
generating and sending a query that (a) specifies the source address information or (b) identifies the source virtualized computing system; and
based on a response to the query, determining the identity information identifying the user.

4. The method of claim 2, wherein obtaining the identity information comprises:
determining the identity information based on the response received from a configuration management database (CMDB) associated with at least one of the following: (a) an infrastructure management platform and (b) a network monitoring tool.

5. The method of claim 2, wherein obtaining the identity information comprises:
determining the identity information based on the response received from a guest operating system (OS) associated with the client system, wherein the guest OS supports a virtual machine (VM) management tool or a network introspection driver.

6. The method of claim 1, wherein obtaining the identity information comprises:
extracting, from the service request, session information specifying (a) the identity information identifying the user, or (b) both the identity information and the particular service tier assigned to the user.

7. The method of claim 1, wherein mapping the service request to the particular service tier comprises:
mapping the service request to the particular service tier based on mapping information accessible by the computer system, wherein the mapping information associates (a) multiple sets of identity information identifying respective multiple users with (b) multiple service tiers assigned to the respective multiple users based on service level agreement (SLA) information.

8. A non-transitory computer-readable storage medium that includes a set of instructions which, in response to execution by a processor of a computer system, cause the processor to perform a method of load balancing with service-tier awareness, wherein the method comprises:
receiving, from a client system, a service request that requires processing by one of multiple server pools that are reachable via the computer system, wherein the multiple server pools are associated with respective multiple service tiers;
obtaining identity information identifying a user associated with the service request from the client system;
based on the identity information, mapping the service request to a particular service tier from the multiple service tiers;
identifying, from the multiple server pools, a particular server pool that is associated with the particular service tier; and
steering the service request towards a destination server for processing, wherein the destination server is selected from the particular server pool associated with the particular service tier.

9. The non-transitory computer-readable storage medium of claim 8, wherein obtaining the identity information comprises:
obtaining the identity information based on (a) source address information specified by the service request or (b) the client system in the form of a source virtualized computing system.

10. The non-transitory computer-readable storage medium of claim 9, wherein obtaining the identity information comprises:
generating and sending a query that (a) specifies the source address information or (b) identifies the source virtualized computing system; and
based on a response to the query, determining the identity information identifying the user.

11. The non-transitory computer-readable storage medium of claim 9, wherein obtaining the identity information comprises:
determining the identity information based on the response received from a configuration management database (CMDB) associated with at least one of the following: (a) an infrastructure management platform and (b) a network monitoring tool.

12. The non-transitory computer-readable storage medium of claim 9, wherein obtaining the identity information comprises:
determining the identity information based on the response received from a guest operating system (OS) associated with the client system, wherein the guest OS supports a virtual machine (VM) management tool or a network introspection driver.

13. The non-transitory computer-readable storage medium of claim 8, wherein obtaining the identity information comprises:
extracting, from the service request, session information that includes (a) the identity information identifying the user, or (b) both the identity information and the particular service tier assigned to the user.

14. The non-transitory computer-readable storage medium of claim 8, wherein mapping the service request to the particular service tier comprises:
mapping the service request to the particular service tier based on mapping information accessible by the computer system, wherein the mapping information associates (a) multiple sets of identity information identifying respective multiple users with (b) multiple service tiers assigned to the respective multiple users based on service level agreement (SLA) information.

15. A load balancer, comprising:
(a) a service tier mapper to:
receive, from a client system, a service request that requires processing by one of multiple server pools that are reachable via the load balancer, wherein the multiple server pools are associated with respective multiple service tiers;
obtain identity information identifying a user associated with the service request from the client system; and
based on the identity information, map the service request to a particular service tier from the multiple service tiers; and
(b) a destination server selector to:
identify, from the multiple server pools, a particular server pool that is associated with the particular service tier; and
selecting a destination server from the particular server pool associated with the particular service tier and steering the service request towards the destination server for processing.

16. The load balancer of claim 15, wherein the service tier mapper is to obtain the identity information by performing the following:
obtain the identity information based on (a) source address information specified by the service request or (b) the client system in the form of a source virtualized computing system.

17. The load balancer of claim 16, wherein the service tier mapper is to obtain the identity information by performing the following:
generate and send a query that (a) specifies the source address information or (b) identifies the source virtualized computing system; and
based on a response to the query, determining the identity information identifying the user.

18. The load balancer of claim 16, wherein the service tier mapper is to obtain the identity information by performing the following:
determine the identity information based on the response received from a configuration management database (CMDB) associated with at least one of the following: (a) an infrastructure management platform and (b) a network monitoring tool.

19. The load balancer of claim 16, wherein the service tier mapper is to obtain the identity information by performing the following:
determine the identity information based on the response received from a guest operating system (OS) associated with the client system, wherein the guest OS supports a virtual machine (VM) management tool or a network introspection driver.

20. The load balancer of claim 16, wherein the service tier mapper is to obtain the identity information by performing the following:
extract, from the service request, session information that includes (a) the identity information identifying the user, or (b) both the identity information and the particular service tier assigned to the user.

21. The load balancer of claim 15, wherein the service tier mapper is to map the service request to the particular service tier by performing the following:
map the service request to the particular service tier based on mapping information accessible by the computer system, wherein the mapping information associates (a) multiple sets of identity information identifying respective multiple users with (b) multiple service tiers assigned to the respective multiple users based on service level agreement (SLA) information.
